(19) United States
(12) Patent Application Publication
(10) Pub. No.: US 2012/0176030 A1
(43) Pub. Date: Jul. 12, 2012

(54) PLASMA DISPLAY PANEL

(76) Inventors: Shinichiro Hori, Osaka (JP); Koichi Mizuno, Shiga (JP); Kimio Amemiya, Osaka (JP)

(21) Appl. No.: 13/395,023

(22) PCT Filed: Jan. 27, 2011
(86) PCT No.: PCT/JP2011/000436

§ 371 Date: Mar. 8, 2012

(30) Foreign Application Priority Data
Feb. 8, 2010 (JP) 2010-025079
Feb. 8, 2010 (JP) 2010-025080

(51) Int. Cl. H01J 17/49

(52) U.S. Cl. 313/586

(57) ABSTRACT

A plasma display panel includes a front plate, and a rear plate disposed oppositely to the front plate and having barrier ribs to partition a discharge cell between the front plate and the rear plate. The front plate has a first electrode and a second electrode in parallel with the first electrode inside the discharge cell. The first electrode includes a first bus electrode, and a plurality of first transparent electrodes electrically connected to the first bus electrode and protruding toward a second-electrode side. The second electrode includes a second bus electrode, and a plurality of second transparent electrodes electrically connected to the second bus electrode and protruding toward a first-electrode side. A discharge gap is provided between tips of the plurality of first transparent electrodes and tips of the plurality of second transparent electrodes.

### TECHNICAL FIELD

A technique of the present disclosure relates to a plasma display panel used for a display device.

### BACKGROUND ART

A plasma display panel (hereinafter referred to as the PDP) has a structure where a pair of substrates is disposed oppositely to each other such that a discharge space is formed therebetween. The discharge space is partitioned into a plurality of spaces with barrier ribs disposed on the substrate, to constitute a plurality of discharge cells. In order to generate discharge in the discharge space partitioned with the barrier ribs, a display electrode and a data electrode are disposed on the substrate. Phosphors that emit red, green or blue light by discharge are provided on the substrate. The PDP excites the phosphors by means of ultraviolet light generated by discharge, and respectively emits red, green and blue visible light from the discharge cells, to display an image.

In the PDP, the display electrode is configured by a wide, strip-shaped transparent electrode and a bus line as a metal electrode which is superimposed on the transparent electrode, so as to increase light-emitting luminance at the time of image display. Hence an area of the display electrode increases. In order to suppress a discharge current that increases due to this configuration, or to eliminate the transparent electrode for reducing the number of production steps, a display electrode divided into a plurality of portions and provided with openings has been used (e.g. Patent Literature 1).

### CITATION LIST

### Patent Literature

PTL 1: International Patent Publication No. 02/017345

### SUMMARY OF THE INVENTION

A plasma display panel is provided with a front plate, and a rear plate disposed oppositely to the front plate and having barrier ribs to partition a discharge cell between the front plate and the rear plate. The front plate has a first electrode and a second electrode in parallel with the first electrode inside the discharge cell. The first electrode includes a first bus electrode, and a plurality of first transparent electrodes electrically connected to the first bus electrode and protruding toward a second-electrode side. The second electrode includes a second bus electrode, and a plurality of second transparent electrodes electrically connected to the second bus electrode and protruding toward a first-electrode side. A discharge gap is provided between tips of the plurality of first transparent electrodes and tips of the plurality of second transparent electrodes.

### BRIEF DESCRIPTION OF DRAWINGS

FIG. 1 is an exploded perspective view showing a PDP according to a first exemplary embodiment.

FIG. 2 is a sectional view showing a configuration of discharge cell portions of the PDP according to the first exemplary embodiment.

FIG. 3 is an electrode array diagram of the PDP according to the first exemplary embodiment.

FIG. 4 is a block diagram showing an overall configuration of a plasma display device using the PDP according to the first exemplary embodiment.

FIG. 5 is a waveform diagram showing waveforms of drive voltages to be applied to respective electrodes in the PDP according to the first exemplary embodiment.

FIG. 6A is a plan view showing an arrangement relation among a scan electrode and a sustain electrode, which constitute a display electrode, and barrier ribs in the PDP according to the first exemplary embodiment.

FIG. 6B is a plan view showing a detail of an arrangement relation between the sustain electrode constituting the display electrode and the barrier ribs in the PDP according to the first exemplary embodiment.

FIG. 7 is a plan view showing another example of the arrangement relation among the scan electrode and the sustain electrode, which constitute the display electrode, and the barrier ribs in the PDP according to the first exemplary embodiment.

FIG. 8 is a plan view showing an arrangement relation among the scan electrode and the sustain electrode, which constitute the display electrode, and the barrier ribs in a PDP according to a second exemplary embodiment.

FIG. 9 is a plan view showing another example of the arrangement relation among the scan electrode and the sustain electrode, which constitute the display electrode, and the barrier ribs in the PDP according to the second exemplary embodiment.

### DESCRIPTION OF EMBODIMENTS

### First Exemplary Embodiment

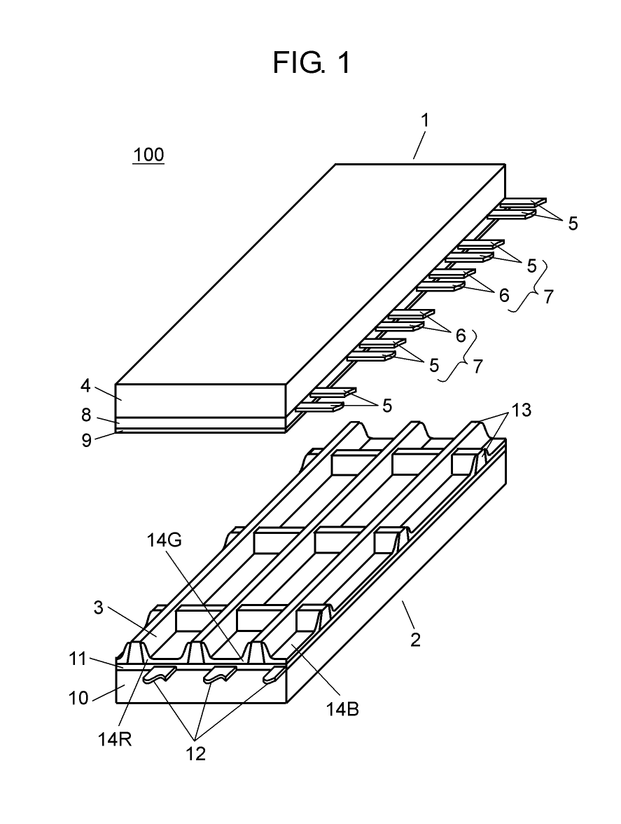

First, an overall configuration of PDP 100 according to a first exemplary embodiment will be described with reference to FIGS. 1 to 3.

As shown in FIG. 1, PDP 100 is configured by front plate 1 and rear plate 2. Front plate 1 and rear plate 2 are disposed oppositely to each other so as to form discharge space 3 therebetween.

Front plate 1 is composed with substrate 4, display electrodes 7, dielectric layer 8 and protective film 9. A plurality of conductive display electrodes 7 is arrayed in a row direction on glass-made substrate 4. Display electrode 7 is composed with scan electrode 5 as a first electrode and sustain electrode 6 as a second electrode. Scan electrode 5 and sustain electrode 6 are disposed in parallel with each other with a discharge gap provided therebetween. Dielectric layer 8 made of a glass material is formed so as to cover scan electrodes 5 and sustain electrodes 6. Protective film 9 made of magnesium oxide (MgO) is formed on dielectric layer 8.

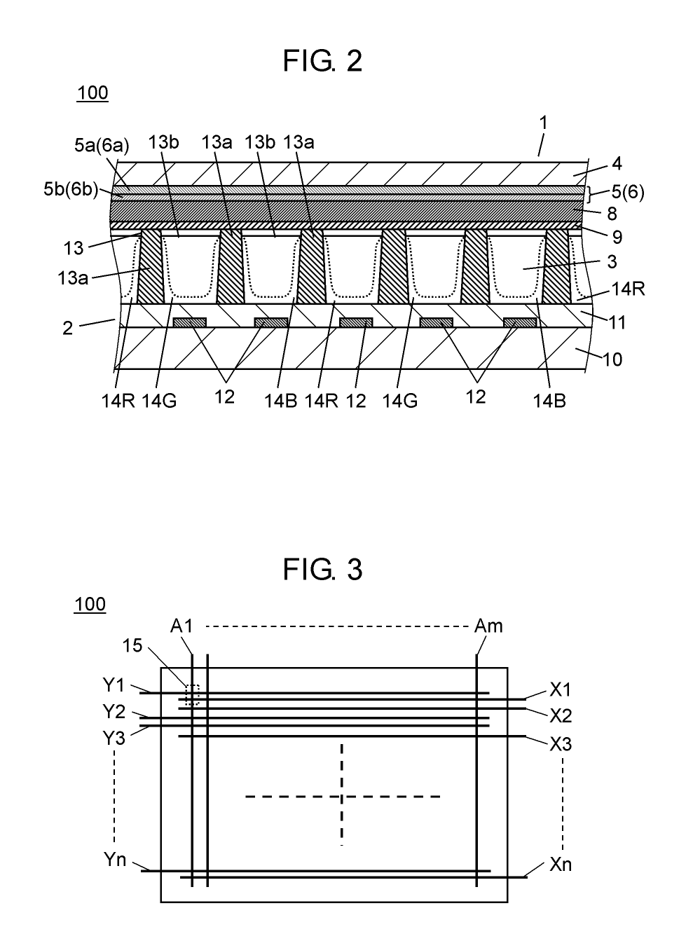

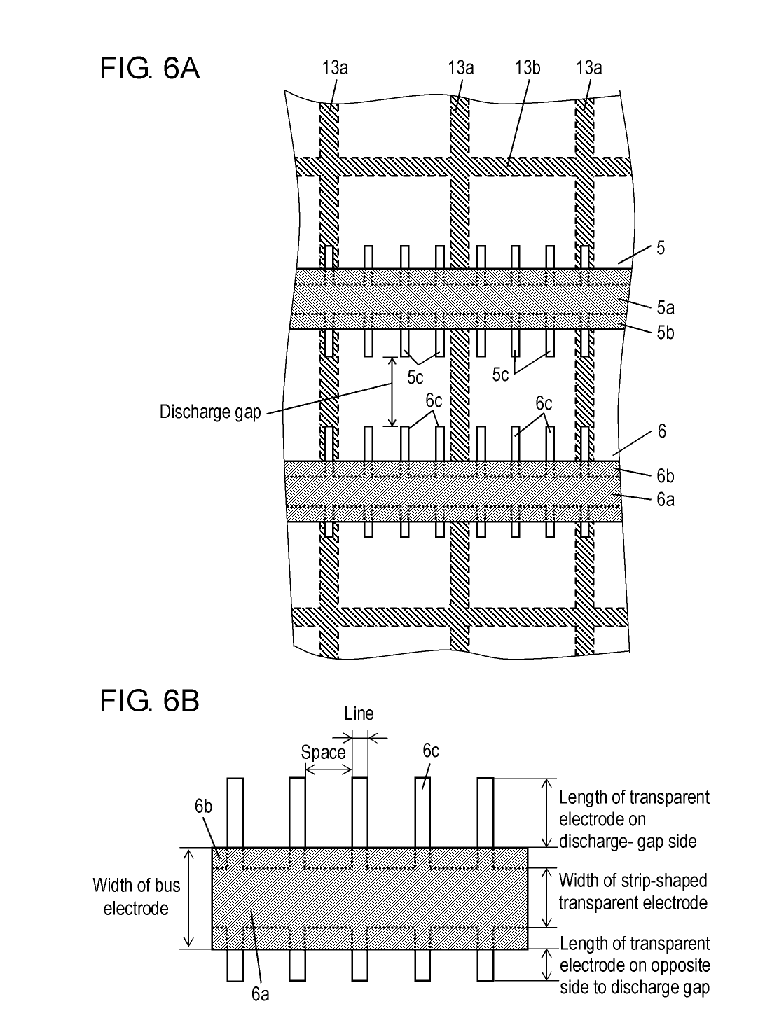

As shown in FIG. 2, scan electrode 5 is composed with transparent electrode 5a as a third transparent electrode, transparent electrodes 5c as first transparent electrodes which will be shown later in FIG. 6A, and bus electrode 5b as a first bus electrode formed by being electrically connected to transparent electrode 5a and transparent electrodes 5c.

Sustain electrode 6 is composed with transparent electrode 6a as a fourth transparent electrode, transparent electrodes 6c as second transparent electrodes which will be shown later in FIG. 6A, and bus electrode 6b as a second bus electrode formed by being electrically connected to transparent electrode 6a and transparent electrodes 6c.

Transparent electrodes 5a, 5c, 6a, 6c are indium tin oxide (ITO) or the like. Bus electrodes 5b, 6b include a conductive metal such as silver (Ag). The configurations of scan electrode 5 and sustain electrode 6 will be described in detail later.

As shown in FIG. 1, rear plate 2 is composed with substrate 10, insulating layer 11, data electrodes 12, barrier ribs 13 and phosphor layers 14R, 14G, 14B. A plurality of lines of data electrodes 12 made of Ag is provided on glass-made substrate 10. Data electrodes 12 are arrayed in stripes in a column direction. Data electrodes 12 are covered with insulating layer 11 made of the glass material. Parallel-cross barrier ribs 13 made of the glass material are provided on insulating layer 11. Barrier ribs 13 partition discharge space 3 formed between front plate 1 and rear plate 2 with respect to each discharge cell 15. Red (R), green (G) and blue (B) phosphor layers 14R, 14G, 14B are provided on a front face of insulating layer 11 and side faces of barrier ribs 13.

Herein, as shown in FIG. 2, parallel-cross barrier ribs 13 to form discharge cells 15 are composed with vertical barrier ribs 13a and horizontal barrier ribs 13b. Vertical barrier rib 13a is formed in parallel with data electrode 12. Horizontal barrier rib 13b is formed so as to be orthogonal to vertical barrier rib 13a. Phosphor layers 14R, 14G, 14B are applied inside barrier ribs 13 in stripes along vertical barrier ribs 13a. Phosphor layers 14R, 14G, 14B are arrayed in an order of blue phosphor layer 14B, red phosphor layer 14R and green phosphor layer 14G.

Then, front plate 1 and rear plate 2 are disposed oppositely to each other such that scan electrodes 5 and sustain electrodes 6 intersect with data electrodes 12. As shown in FIG. 3, discharge cell 15 is provided in an area where scan electrode 5 and sustain electrode 6 intersect with data electrode 12. Discharge space 3 is filled, for example, with a mixed gas of neon and xenon as a discharge gas. It is to be noted that the structure of PDP 100 is not restricted to the one described above. The structure of PDP 100 may, for example, be one provided with striped barrier ribs.

Scan electrodes 5 are composed with n-lines of scan electrodes Y1, Y2, Y3 . . . Yn extending in the row direction. Sustain electrodes 6 are composed with n-lines of sustain electrodes X1, X2, X3 . . . Xn extending in the row direction. Data electrodes 12 are composed with m-lines of data electrodes A1 . . . Am extending in the column direction. Discharge cell 15 is formed in an area where a pair of scan electrode Yp and sustain electrode Xp (1≦p≦n) intersect with one line of data electrode Aq (1≦q≦m). m×n pieces of discharge cells 15 are formed inside discharge space 3. Scan electrode 5 and sustain electrode 6 are formed on front plate 1 in a pattern of scan electrode Y1, sustain electrode X1, sustain electrode X2, scan electrode Y2 . . . . Scan electrode 5 and sustain electrode 6 are connected to a terminal of a drive circuit provided outside an image display area formed with discharge cells 15.

A description will be given below of an overall configuration and a driving method of plasma display device 200 using foregoing PDP 100.

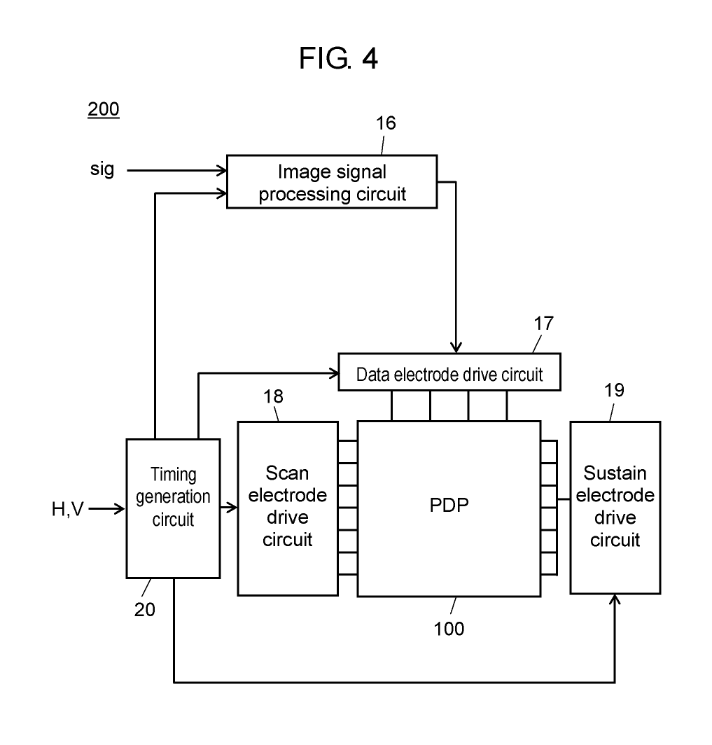

As shown in FIG. 4, plasma display device 200 is provided with PDP 100 having the configuration shown in FIGS. 1 to 3, image signal processing circuit 16, data electrode drive circuit 17, scan electrode drive circuit 18, sustain electrode drive circuit 19, timing generation circuit 20, and a power supply circuit (not shown). Data electrode drive circuit 17 is connected to one ends of data electrodes 12 in PDP 100. Data electrode drive circuit 17 has a plurality of data drivers composed with semiconductor elements for supplying voltages to data electrodes 12. Data electrodes 12 are divided into a plurality of blocks, with several data electrodes 12 taken as one block. Data electrodes 12 in units of the blocks are connected to the data drivers using an electrode extracting section provided at a lower end of PDP 100.

In FIG. 4, image signal processing circuit 16 converts image signal sig to image data with respect to each subfield. Data electrode drive circuit 17 converts the image data with respect to each subfield to signals corresponding to respective data electrodes A1 to Am, to drive respective data electrodes A1 to Am. Timing generation circuit 20 generates a variety of timing signals based on horizontal synchronizing signal H and vertical synchronizing signal V, and supplies the variety of timing signals to respective drive circuit blocks. Scan electrode drive circuit 18 supplies a drive voltage waveform to each of scan electrodes Y1 to Yn based on the timing signal. Sustain electrode drive circuit 19 supplies a drive voltage waveform to each of sustain electrodes X1 to Xn based on the timing signal. In addition, one ends of the sustain electrodes are commonly connected inside PDP 100 or outside PDP 100, and the commonly connected wire is connected to sustain electrode drive circuit 19.

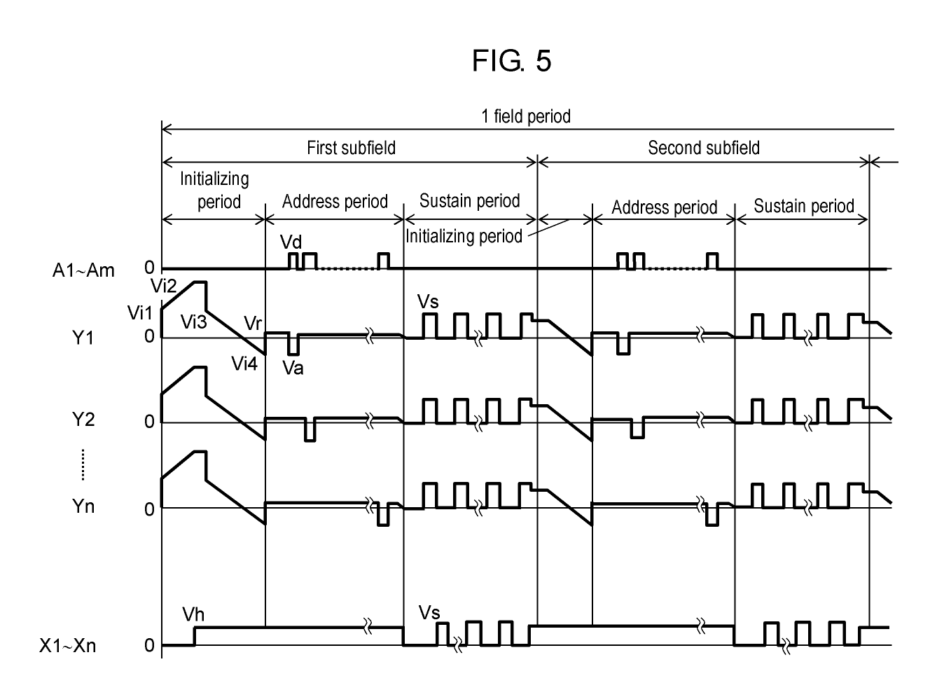

Next, drive voltage waveforms for driving PDP 100 and operations thereof will be described with reference to FIG. 5.

In PDP 100 according to the first exemplary embodiment, one field is divided into a plurality of subfields, and each subfield has an initializing period, an address period, and a sustain period.

In the initializing period of a first subfield, data electrodes A1 to Am and sustain electrodes X1 to Xn are held at 0(V). A ramp voltage, which gradually rises from voltage Vi1(V) being not higher than a discharge start voltage toward voltage Vi2(V) exceeding the discharge start voltage, is applied to each of scan electrodes Y1 to Yn. Then, first weak initializing discharge is generated in every discharge cell 15, and a negative wall voltage is accumulated on a top of each of scan electrodes Y1 to Yn. Further, positive wall voltages are accumulated on tops of sustain electrodes X1 to Xn and data electrodes A1 to Am. The wall voltage on the top of the electrode here means a voltage generated by a wall charge accumulated on the dielectric layer which covers the electrodes, the phosphor layer and the like.

Thereafter, sustain electrodes X1 to Xn are held at positive voltage Vh(V), and each of scan electrodes Y1 to Yn is applied with a ramp voltage which gradually falls from voltage Vi3(V) toward voltage Vi4(V). Thereupon, second weak initializing discharge is generated in every discharge cell 15. Thereby, the wall voltages between the tops of scan electrodes Y1 to Yn and the tops of sustain electrodes X1 to Xn are weakened, to be adjusted to values appropriate for an address operation. The wall voltages on the tops of data electrodes A1 to Am are also adjusted to values appropriate for the address operation.

In the subsequent address period, scan electrodes Y1 to Yn are once held at Vr(V). Next, negative scan pulse voltage Va(V) is applied to scan electrode Y1 on a first row. Further, positive address pulse voltage Vd(V) is applied to data electrode Ak (k=1 to m) in discharge cell 15 to be displayed on the first row out of data electrodes A1 to Am. At this time, a voltage at an intersecting section of this data electrode Ak and scan electrode Y1 is one obtained by adding the wall voltage on the top of data electrode Ak and the wall voltage on the top of scan electrode Y1 to external applied voltage (Vd−Va)(V), and it exceeds the discharge start voltage. Then, address discharge is generated between data electrode Ak and scan electrode Y1, and between sustain electrode X1 and scan electrode Y1. Thereby, the positive wall voltage is accumulated on the top of scan electrode Y1 in this discharge cell 15, and the negative wall voltage is accumulated on the top of sustain electrode X1 therein. At this time, the negative wall voltage is also accumulated on the top of data electrode Ak.

In this manner, the address discharge is generated in discharge cell 15 to be displayed on the first row, and the address operation is performed to accumulate the wall voltage on the top of each electrode. Meanwhile, voltages at the intersecting sections of data electrodes A1 to Am and scan electrode Y1, to which the address pulse voltage Vd(V) has not been applied, do not exceed the discharge start voltage, and hence the address discharge is not generated. The above address operation is sequentially performed up to discharge cell 15 on an n-th row, and the address period is completed.

In the subsequent sustain period, positive sustain pulse voltage Vs(V) as a first voltage is applied to each of scan electrodes Y1 to Yn. A ground potential, namely 0(v), is applied as a second voltage to each of sustain electrodes X1 to Xn. At this time, in discharge cell 15 where the address discharge has been generated, a voltage between the top of scan electrode Yi (i=1 to n) and the top of sustain electrode Xi is one obtained by adding the wall voltage on the top of scan electrode Yi and the wall voltage on the top of sustain electrode Xi to sustain pulse voltage Vs(V), and it exceeds the discharge start voltage. Then, sustain discharge is generated between scan electrode Yi and sustain electrode Xi, and by means of ultraviolet rays generated at this time, the phosphor layer emits light. Thereby, the negative wall voltage is accumulated on the top of scan electrode Yi, and the positive wall voltage is accumulated on the top of sustain electrode Xi. At this time, the positive wall voltage is also accumulated on data electrode Ak.

In discharge cell 15 where the address discharge has not been generated in the address period, the sustain discharge is not generated, and the wall voltage at the end of the initializing period is held. Subsequently, 0(v) as the second voltage is applied to each of scan electrodes Y1 to Yn. Sustain pulse voltage Vs (V) as the first voltage is applied to each of sustain electrodes X1 to Xn. Then, in discharge cell 15 where the sustain discharge has been generated, a voltage between the top of sustain electrode Xi and the top of scan electrode Yi exceeds the discharge start voltage, and hence the sustain discharge is generated again between sustain electrode Xi and scan electrode Yi. Then, the negative wall voltage is accumulated on the top of sustain electrode Xi, and the positive wall voltage is accumulated on the top of scan electrode Yi.

Hereinafter, as in the above, sustain pulses in the number corresponding to luminance weight are alternately applied to scan electrodes Y1 to Yn and sustain electrodes X1 to Xn, whereby the sustain discharge is continuously performed in discharge cell 15 where the address discharge has been generated in the address period. In this manner, the sustain operation in the sustain period is completed. Since operations in an initializing period, an address period and a sustain period in a subsequent subfield are almost the same as the operations in the first subfield, descriptions thereof are omitted.

Next, a configuration of display electrode 7 in PDP 100 according to the first exemplary embodiment will be described in more detail.

Although barrier ribs 13 shown in FIG. 6A are originally disposed on the front side in the paper, those are shown on the back of scan electrode 5 and sustain electrode 6 for the sake of convenience in description.

As shown in FIG. 6A, display electrode 7 is provided with discharge gaps between tips of a plurality of transparent electrodes 5c toward a sustain-electrode-6 side and tips of a plurality of transparent electrodes 6c toward a scan-electrode-5 side.

Scan electrode 5 has strip-shaped bus electrode 5b, strip-shaped transparent electrode 5a in parallel with bus electrode 5b, and the plurality of transparent electrodes 5c protruding from bus electrode 5b. Bus electrode 5b is formed on transparent electrode 5a and the plurality of protruding transparent electrodes 5c. Bus electrode 5b is electrically connected to transparent electrode 5a and the plurality of transparent electrodes 5c. The plurality of transparent electrodes 5c protrudes in a direction perpendicular to an extending direction of bus electrode 5b. Further, the plurality of transparent electrodes 5c protrudes from both sides of transparent electrode 5a and bus electrode 5b. That is, one side of pluralities of transparent electrodes 5c protrudes toward a discharge-gap side as sustain-electrode-6 side. Further, the other side of the plurality of transparent electrodes 5c protrudes toward the opposite side to the discharge gap. Transparent electrodes 5c toward the discharge-gap side and transparent electrodes 5c toward the opposite side are formed on the same straight line. The plurality of transparent electrodes 5c is electrically connected by transparent electrode 5a and bus electrode 5b.

Like scan electrode 5, sustain electrode 6 has strip-shaped bus electrode 6b, strip-shaped transparent electrode 6a in parallel with bus electrode 6b, and the plurality of transparent electrodes 6c protruding from bus electrode 6b. Bus electrode 6b is formed on transparent electrode 6a and the plurality of protruding transparent electrodes 6c. Bus electrode 6b is electrically connected to transparent electrode 6a and the plurality of transparent electrodes 6c. The plurality of transparent electrodes 6c protrudes in a direction perpendicular to an extending direction of bus electrode 6b. Further, the plurality of transparent electrodes 6c protrude from both sides of transparent electrode 6a and bus electrode 6b. That is, one side of the pluralities of transparent electrodes 6c protrudes toward a discharge-gap side as scan-electrode-5 side. Further, the other side of the plurality of transparent electrodes 6c protrudes toward the opposite side to the discharge gap. Transparent electrodes 6c toward the discharge-gap side and transparent electrodes 6c toward the opposite side are formed on the same straight line. The plurality of transparent electrodes 6c is electrically connected by transparent electrode 6a and bus electrode 6b.

Herein, a result of an experiment conducted by the present inventors will be described.

### EXAMPLES

In the present experiment, transparent electrodes 5a, 5c, 6a, 6c are ITO. Film thicknesses of transparent electrodes 5a, 5c, 6a, 6c are 0.2 μm. Bus electrodes 5b, 6b each include a black pigment, a glass material and Ag. The film thicknesses of bus electrodes 5b, 6b are on the order of 5 μm. Transparent electrodes 5a, 5c, 6a, 6c and bus electrodes 5b, 6b were formed by photolithography. Dielectric layer 8 is a glass material obtained by mixing silica particles as a filler into glass mainly composed of silica dioxide (SiO₂) and boracic acid (B₂O₃). A relative dielectric constant of dielectric layer 8 is on the order of 5 to 7. Vertical barrier ribs 13a are formed at pitches of 148 μm in the extending direction of display electrode 7. That is, the pitch of discharge cell 15 in the extending direction of display electrode 7 is 148 μm. Dielectric layer 8 was formed by screen printing. However, the first exemplary embodiment is not restricted to the above materials, configuration and method.

FIG. 6B shows a configuration of sustain electrode 6. A configuration of scan electrode 5 is similar to the configuration of the sustain electrode. In the present experiment, PDPs 100 with three parameters subjected to change were produced. A first one is a film thickness of dielectric layer 8, though not shown in FIG. 6B. A second one is a width (line) of each of transparent electrodes 5c, 6c. The line is a length of each of transparent electrodes 5c, 6c in the extending direction of display electrode 7. A third one is a distance (space) between each adjacent transparent electrodes 5c, 6c. The space is a distance between each two adjacent transparent electrodes 5c, 6c in the extending direction of display electrode 7. A pair, which will be shown in Table 1 later, is a total of one line and one space. The number of pairs is the number of pairs provided inside discharge cell 15. It is to be noted that discharge cell 15 for use in the example has at least 3.0 pairs. Widths of bus electrodes 5b, 6b are 65 μm. The widths of bus electrodes 5b, 6b are lengths of bus electrodes 5b, 6b in a direction perpendicular to the extending direction of display electrode 7. Widths of transparent electrodes 5a, 6a are 35 μm. The widths of strip-shaped transparent electrodes 5a, 6a are lengths of transparent electrodes 5a, 6a in the direction perpendicular to the extending direction of display electrode 7. Transparent electrodes 5a, 6a are covered, while having distances of the order of 15 μm from both ends of bus electrodes 5b, 6b. The lengths of transparent electrodes 5c, 6c toward the discharge-gap side are 40 μm. A length of transparent electrode 5c toward the discharge-gap side is a length of transparent electrode 5 protruding toward the sustain-electrode-6 side from bus electrode 5b in the direction perpendicular to the extending direction of display electrode 7. A length of transparent electrode 6c toward the discharge-gap side is a length of transparent electrode 6c protruding toward the scan-electrode-5 side from bus electrode 6b in the direction perpendicular to the extending direction of display electrode 7. Lengths of transparent electrodes 5c, 6c toward the opposite side to the discharge gap are 20 μm. A length of transparent electrode 5c toward the opposite side to the discharge gap is a length of transparent electrode 5c protruding toward an adjacent-discharge-cell-15 side from bus electrode 5b via horizontal barrier rib 13b in the direction perpendicular to the extending direction of display electrode 7. A length of transparent electrode 6c toward the opposite side to the discharge gap is a length of transparent electrode 6c protruding toward the adjacent-discharge-cell-15 side from bus electrode 6b via horizontal barrier rib 13b in the direction perpendicular to the extending direction of display electrode 7. A distance of the discharge gap is 80 μm. The distance of the discharge gap is a distance between the tips of transparent electrodes 5c toward the discharge-gap side and the tips of transparent electrodes 6c toward the discharge-gap side.

In each of Examples 1 to 10 and Comparative Example with three parameters subjected to change, an emission efficiency was measured. A PDP of Comparative Example has striped transparent electrodes and a bus electrode superimposed toward the transparent electrodes. The emission efficiency is a relative value to the emission efficiency of Comparative Example (indicated as “1.00” in the table).

TABLE 1

| | Film | | | | | |
|---|---|---|---|---|---|---|
| | thickness | | | | | Emission |
| | of | | | | Number | efficiency |
| | dielectric | Line | Space | Pair | of pairs | (relative |
| | layer (μm) | (μm) | (μm) | (μm) | (Pair) | value) |
| Example 1 | 22 | 15 | 25 | 40 | 3.7 | 1.10 |
| Example 2 | 22 | 18 | 22 | 40 | 3.7 | 1.05 |
| Example 3 | 22 | 22 | 18 | 40 | 3.7 | 1.04 |
| Example 4 | 22 | 25 | 15 | 40 | 3.7 | 1.03 |
| Example 5 | 22 | 10 | 15 | 25 | 6.0 | 1.04 |
| Example 6 | 22 | 15 | 15 | 30 | 5.0 | 1.03 |
| Example 7 | 22 | 22.5 | 15 | 37.5 | 4.0 | 1.04 |
| Example 8 | 22 | 35 | 15 | 50 | 3.0 | 1.03 |
| Example 9 | 20 | 15 | 20 | 35 | 4.2 | 1.08 |
| Example 10 | 20 | 15 | 15 | 30 | 5.0 | 1.02 |
| Comparative | 22 | — | (0) | — | — | 1.00 |
| Example | | | | | | |

Table 1 is a table indicating a result of the experiment using PDP 100 in the first exemplary embodiment. As shown in Table 1, in the present experiment, PDP 100 with dielectric layer 8 having a film thickness of 22 μm was produced as Examples 1 to 8. In Examples 1 to 4, the line and the space were changed, with a length of the pair fixed to 40 μm. In Examples 4 to 8, lengths of the line and the pair and the number of pairs were changed, with the space fixed to 15 μm. Further, as Examples 9 and 10, PDP 100 with dielectric layer 8 having a film thickness of 20 μm was produced. In Examples 9 and 10, the lengths of the space and the pair and the number of pairs were changed, with the line fixed to 15 μm. Comparative Example corresponds to PDP 100 of each of Examples 1 to 8 with its space set to zero.

First, Examples 1 to 10 show that the emission efficiency of PDP 100 of the first exemplary embodiment is improved as compared with that of Comparative Example. Examples 4 to 8 show that, when the space is made constant with respect to the film thickness of dielectric layer 8, the emission efficiency becomes almost an equivalent value. Examples 1 to 4 show that the emission efficiency increases with increase in space. In Example 1, the space is 25 μm, which is larger than the film thickness of dielectric layer 8, and the emission efficiency is 1.10. On the other hand, in Example 4, the space is 15 μm, which is smaller than the film thickness of dielectric layer 8, and the emission efficiency is 1.03. Although the reason for this phenomenon has not been clarified, the emission efficiency improves when the space is not smaller than the film thickness of dielectric layer 8. This is also shown in Example 1 and Example 6. In Example 1 and Example 6, the lines are the same being 15 μm, and the spaces were changed, In Example 1, the space is 25 μm, which is larger than the film thickness of dielectric layer 8, and the emission efficiency is 1.10. On the other hand, in Example 6, the space is 15 μm, which is smaller than the film thickness of dielectric layer 8, and the emission efficiency is 1.03.

As thus described, in PDP 100 of the first exemplary embodiment, a plurality of the discharge gaps are provided between scan electrode 5 and sustain electrode 6 having a plurality of transparent electrodes 5c and a plurality of transparent electrodes 6c which are disposed oppositely to each other, to reduce reactive power so as to improve the emission efficiency. Further, in PDP 100 of the first exemplary embodiment, the emission efficiency improves with increase in space. As shown in Examples 1, 2 and 9, in PDP 100 of the first exemplary embodiment, the emission efficiency improves by not less than 5% when the space is not smaller than the film thickness of dielectric layer 8. For this reason, PDP 100 of the first exemplary embodiment desirably has a space not smaller than the film thickness of dielectric layer 8. It should be noted that, since PDP 100 of the first exemplary embodiment has at least two each of transparent electrodes 5c, 6c inside the pitch of discharge cell 15, the space needs to be not larger than a length obtained by subtracting two lines from the pitch of discharge cell 15.

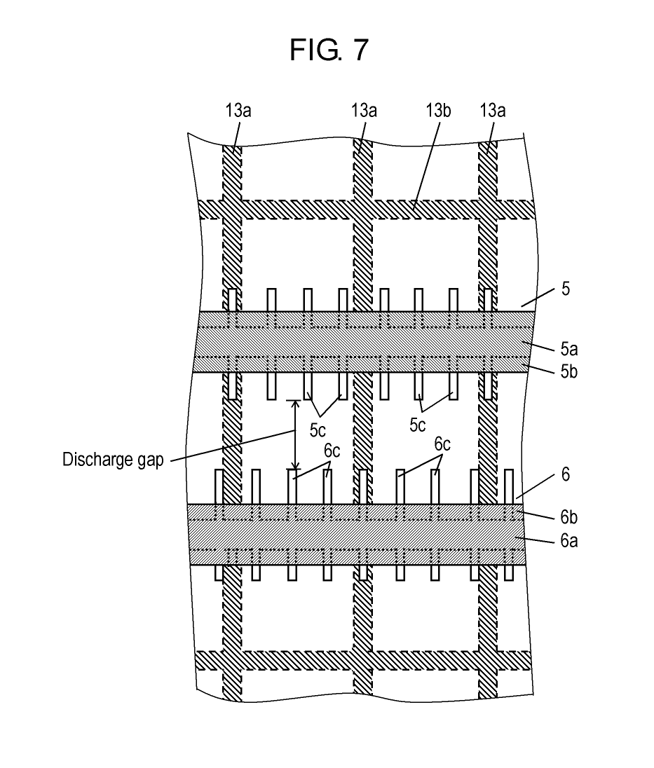

Although barrier ribs 13 shown in FIG. 7 are originally disposed on the front side in the paper, those are shown on the back of scan electrode 5 and sustain electrode 6 for the sake of convenience in description.

It is to be noted that as shown in FIG. 7, the tip of transparent electrodes 5c in scan electrode 5 may be disposed between the tips of transparent electrodes 6c in sustain electrode 6. That is, the tips of transparent electrodes 5c may be disposed closer to the scan-electrode-5 side than the tips of transparent electrodes 6c in an area where transparent electrode 6c is not formed. The tip of transparent electrodes 6c in sustain electrode 6 may be disposed between the tips of transparent electrodes 5c in sustain electrode 5. That is, the tips of transparent electrodes 6c are disposed closer to the sustain-electrode-6 side than the tips of transparent electrodes 5c in an area where transparent electrode 5c is not formed. Also in PDP 100 using display electrodes 7 as thus described, it was possible to reduce the reactive power, so as to improve emission efficiency, as in foregoing Examples 1 to 10.

In addition, although scan electrode 5 in the first exemplary embodiment has the plurality of transparent electrodes 5c protruding from both sides of bus electrode 5b, such a configuration is not restrictive. Further, sustain electrode 6 has the plurality of transparent electrodes 6c protruding from both sides of bus electrode 6b, such a configuration is not restrictive. Scan electrode 5 may have at least a plurality of transparent electrodes 5c protruding toward the sustain-electrode-6 side, and sustain electrode 6 may have at least a plurality of transparent electrodes 6c protruding toward the scan-electrode-5 side. However, arranging the plurality of transparent electrodes 5c, 6c from both sides of bus electrodes 5b, 6b allows expansion of discharge generated between transparent electrodes 5c and transparent electrodes 6c, thus leading to improvement in emission efficiency of PDP 100. For this reason, the plurality of transparent electrodes 5c, 6c is desirably disposed from both sides of bus electrodes 5b, 6b. As for the plurality of transparent electrodes 5c, 6c provided from both sides, transparent electrodes 5c, 6c toward the discharge-gap side is desirably longer than transparent electrodes 5c, 6c toward the opposite side. This is for the purpose of preventing erroneous discharge. Further, transparent electrodes 5c, 6c toward a discharge-gap side and transparent electrodes 5c, 6c toward the opposite side may be on the same straight line or may not be on the same straight line.

Moreover, the tips of the plurality of transparent electrodes 5c, 6c preferably includes curves. It is assumed from the result of Examples 1 to 10 that the emission efficiency of PDP 100 depends on areas of transparent electrodes 5c, 6c toward the discharge-gap side. That is, reducing the area of the electrode can further improve the emission efficiency of PDP 100. PDP 100 with the tips of transparent electrodes 5c, 6c including curves can reduce the reactive power more than one using transparent electrodes 5c, 6c with square tips as shown in FIGS. 6A and 7, so as to improve the emission efficiency. Transparent electrodes 5c, 6c with the tips thereof including curves are, for example, transparent electrodes 5c, 6c having circular tips. Further, the shape of the tip is not restricted to the shape including a curve, but may be a shape with the width of transparent electrodes 5c, 6c tapering down toward the discharge-gap side. That is, the tip may have a shape with a pointed end. In addition, although the shape of the tip is not particularly restricted, the distance of the discharge gap is preferably equivalent. This is because, when the distance of the discharge gap increases, a voltage required for discharge also increases.

Further, since the plurality of transparent electrodes 5c, 6c is electrically connected by bus electrodes 5b, 6b, those may not be electrically connected by transparent electrodes 5a, 6a. However, the plurality of transparent electrodes 5c, 6c being electrically connected by transparent electrodes 5a, 6a leads to an increase in contact area of bus electrodes 5b, 6b with transparent electrodes 5c, 6c and transparent electrodes 5a, 6a. When the contact area increases, it is possible to reduce contact resistance among transparent electrodes 5c, 6c, transparent electrodes 5a, 6a and bus electrodes 5b, 6b. Herewith, display electrode 7 electrically connected with the plurality of transparent electrodes 5c, 6c can reduce a voltage required for generation of sustain discharge more than display electrode 7 not connected therewith.

As described above, PDP 100 according to the first exemplary embodiment is configured such that scan electrode 5 includes bus electrode 5b and transparent electrode 5a electrically connected to bus electrode 5b and having the plurality of transparent electrodes 5c toward the sustain-electrode-6 side, sustain electrode 6 includes bus electrode 6b and transparent electrode 6a electrically connected to bus electrode 6b and having the plurality of transparent electrodes 6c toward the scan-electrode-5 side, the tip of at least one of the plurality of transparent electrodes 5c is disposed oppositely to the tip of at least one of the plurality of transparent electrodes 6c, and the discharge gap is provided between the tips of the plurality of transparent electrodes 5c and the tips of the plurality of transparent electrodes 6c, whereby it is possible to reduce the reactive power, so as to improve the emission efficiency.

### Second Exemplary Embodiment

Hereinafter, PDP 100 according to a second exemplary embodiment will be described. The configuration of display electrode 7 with a different configuration from the configuration of that in PDP 100 according to the first exemplary embodiment will be described in details.

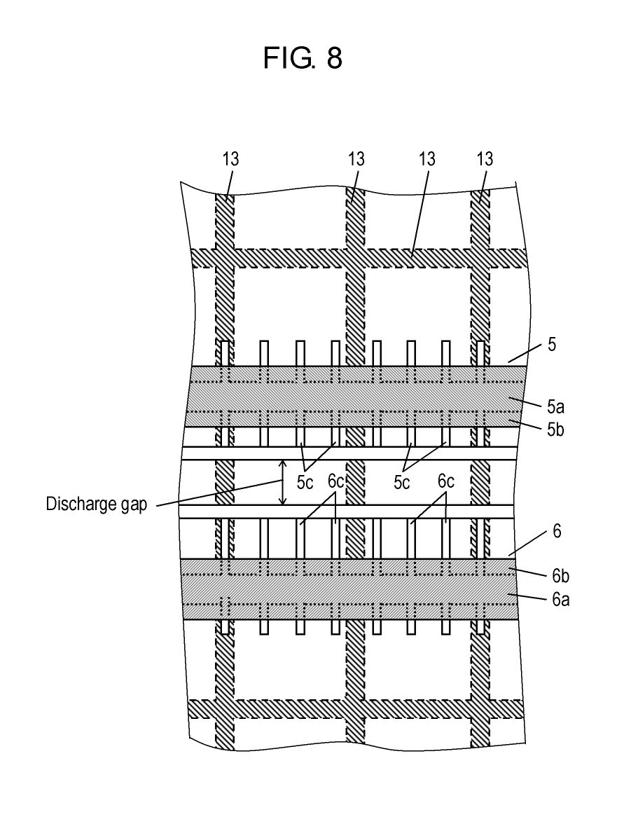

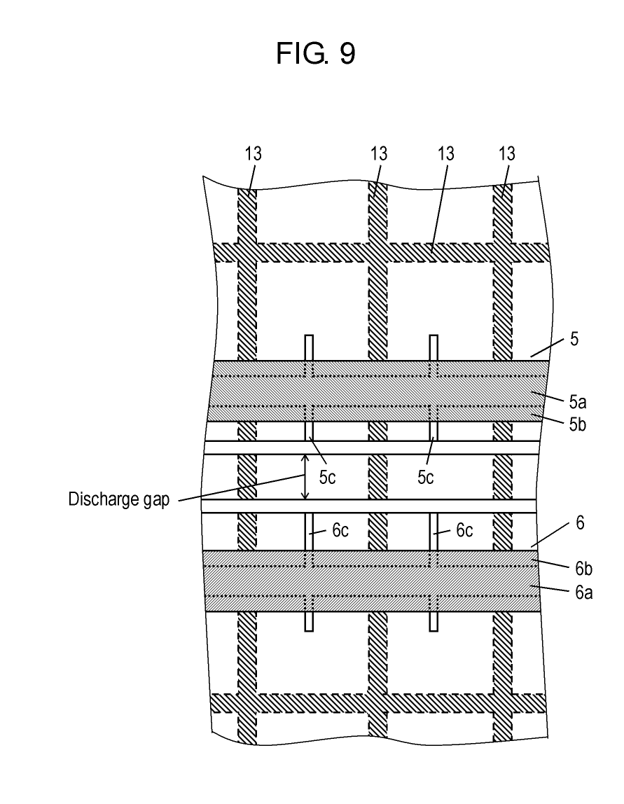

As shown in FIG. 8, display electrode 7 is configured by scan electrode 5 and sustain electrode 6. As shown in FIG. 9, scan electrode 5 has strip-shaped bus electrode 5b as the first bus electrode, and strip-shaped transparent electrode 5a as the third transparent electrode which is electrically connected to bus electrode 5b. Transparent electrode 5a has a plurality of transparent electrodes 5c as the first transparent electrode which protrudes from both sides of bus electrode 5b. The plurality of transparent electrodes 5c protrudes in a direction perpendicular to an extending direction of strip-shaped bus electrode 5b. Sustain electrode 6 has strip-shaped bus electrode 6b as the second bus electrode, and strip-shaped transparent electrode 6a as the fourth transparent electrode which is electrically connected to bus electrode 6b. Transparent electrode 6a has a plurality of transparent electrodes 6c as the second transparent electrode which protrudes from both sides of bus electrode 6b. Transparent electrodes 6c protrude in a direction perpendicular to an extending direction of strip-shaped bus electrode 6b. The tips of the plurality of transparent electrodes 5c toward the sustain-electrode-6 side are disposed oppositely to the tips of the plurality of transparent electrodes 6c toward the scan-electrode-5 side. The tips of the plurality of transparent electrodes 5c toward the sustain-electrode-6 side are electrically connected by means of the same material as that for transparent electrode 5c. The tips of the plurality of transparent electrodes 6c toward the scan-electrode-5 side are electrically connected by means of the same material as that for transparent electrode 6c. Then in display electrode 7, discharge gaps are provided between the tips of the plurality of transparent electrodes 5c toward the sustain-electrode-6 side and the tips of the plurality of transparent electrodes 6c toward the scan-electrode-5 side.

Herein, a result of an experiment conducted by the present inventors will be described. PDP of Comparative Example is the same as Comparative Example according to the first exemplary embodiment. In PDP 100 according to the second exemplary embodiment with a line of 14 μm and a space of 15 μm, the emission efficiency was improved as compared with that in Comparative Example. Further, also in PDP 100 according to the second exemplary embodiment with a line of 20 μm and a space of 20 μm, the emission efficiency was improved as compared with that in Comparative Example.

Further, it has been found as in the first exemplary embodiment that the emission efficiency improves by making the space not smaller than the film thickness of dielectric layer 8.

That is, in PDP 100 of the second exemplary embodiment, the discharge gap is provided between scan electrode 5 and sustain electrode 6 having the plurality of transparent electrodes 5c, 6c whose tips toward the discharge-gap side are electrically connected, whereby it is possible to reduce the reactive power, so as to improve the emission efficiency. Further, in PDP 100 in the second exemplary embodiment, arranging the space not smaller than the film thickness of dielectric layer 8 inside discharge cell 15 can improve the emission efficiency.

Moreover, as shown in FIG. 9, in PDP 100 in the second exemplary embodiment, one transparent electrodes 5c, 6c may be formed in one discharge cell 15 respectively. This PDP 100 is provided with: front plate 1; and rear plate 2, disposed oppositely to front plate 1 and having barrier ribs 13 to partition discharge cell 15 between front plate 1 and rear plate 2, wherein front plate 1 has scan electrode 5 and sustain electrode 6 in parallel with scan electrode 5 inside discharge cell 15, scan electrode 5 includes bus electrode 5b, and transparent electrode 5a electrically connected to bus electrode 5b and having one transparent electrode 5a toward the sustain-electrode-6 side, sustain electrode 6 includes bus electrode 6b, and transparent electrode 6a electrically connected to bus electrode 6b and having one transparent electrode 6c toward the scan-electrode-5 side, a tip of transparent electrode 5c is electrically connected by means of the same material as that for transparent electrode 5c, and electrically connected to a tip of transparent electrode 5c in adjacent discharge cell 15 constituting same scan electrode 5, a tip of transparent electrode 6c is electrically connected by means of the same material as that for transparent electrode 6c, and electrically connected to a tip of transparent electrode 6c in adjacent discharge cell 15 constituting same scan electrode 6, and a discharge gap is provided between the tip of transparent electrode 5c and the tip of transparent electrode 6c.

That is, in PDP 100 shown in FIG. 9, the discharge gap is provided between scan electrode 5 and sustain electrode 6 having transparent electrodes 5c, 6c whose tips toward the discharge-gap side are electrically connected, whereby it is possible to reduce the reactive power, so as to improve the emission efficiency.

As described above, PDP 100 according to the second exemplary embodiment is configured such that scan electrode 5 includes bus electrode 5b and transparent electrode 5a electrically connected to bus electrode 5b and having the plurality of transparent electrodes 5c toward the sustain-electrode-6 side, sustain electrode 6 includes bus electrode 6b and transparent electrode 6a electrically connected to bus electrode 6b and having the plurality of transparent electrodes 6c toward the scan-electrode-5 side, the tips of at least two of the plurality of transparent electrodes 5c are electrically connected by means of the same material as that for transparent electrode 5c, the tips of at least two of the plurality of transparent electrodes 6c are electrically connected by means of the same material as that for transparent electrode 6c, and the discharge gap is provided between the tips of the plurality of transparent electrodes 5c and the tips of the plurality of transparent electrodes 6c, whereby it is possible to reduce the reactive power, so as to improve the emission efficiency.

### INDUSTRIAL APPLICABILITY

As described above, the technique of the present disclosure is a useful technique in realizing improvement in emission efficiency of a plasma display panel.

### REFERENCE MARKS IN THE DRAWING

1 front plate
2 rear plate
3 discharge space
4,10 substrate
5 scan electrode
6 sustain electrode
5a, 6a, 5c, 6c transparent electrode
5b, 6b bus electrode
7 display electrode
8 dielectric layer
9 protective film
11 insulating layer
12 data electrode
13 barrier rib
14R, 14G, 14B phosphor layer
15 discharge cell
16 image signal processing circuit
17 data electrode drive circuit
18 scan electrode drive circuit
19 sustain electrode drive circuit
20 timing generation circuit
100 PDP
200 plasma display device

1-9. (canceled)

10. A plasma display panel, comprising:
a front plate; and
a rear plate, disposed oppositely to the front plate and having barrier ribs to partition a discharge cell between the front plate and the rear plate, wherein
the front plate has a first electrode and a second electrode in parallel with the first electrode inside the discharge cell,
the first electrode includes a first bus electrode, and at least three of a first transparent electrodes electrically connected to the first bus electrode and protruding toward a second-electrode side,
the second electrode includes a second bus electrode, and at least three of a second transparent electrodes electrically connected to the second bus electrode and protruding toward the first-electrode side,
a discharge gap is provided between tips of the first transparent electrodes and tips of the second transparent electrodes,
a dielectric layer covering the first electrode and the second electrode,
a distance between at least two of the first transparent electrodes is not smaller than a film thickness of the dielectric layer, and
a distance between at least two of the second transparent electrodes is not smaller than the film thickness of the dielectric layer.

11. The plasma display panel according to claim 10, wherein
the tips of the first transparent electrodes and the tips of the second transparent electrodes include curves.

12. The plasma display panel according to claim 10, wherein
the first electrode includes a third transparent electrode electrically connecting the first transparent electrodes to the first electrode,
the third transparent electrode is covered with the first bus electrode,
the second electrode includes a fourth transparent electrode electrically connecting the second transparent electrodes to the second electrode, and
the fourth transparent electrode is covered with the second bus electrode.

13. The plasma display panel according to claim 10, wherein
the first transparent electrodes protrude from both sides of the first bus electrode, and
the second transparent electrodes protrude from both sides of the second bus electrode.

14. The plasma display panel according to claim 10, wherein
a tip of at least one of the first transparent electrodes is disposed oppositely to a tip of at least one of the second transparent electrodes.

15. The plasma display panel according to claim 10, wherein
a tip of at least one of the first transparent electrodes is disposed between tips of two of the second transparent electrodes.

16. The plasma display panel according to claim 10, wherein
at least two tips of the first transparent electrodes are electrically connected to each other, and
at least two tips of the second transparent electrodes are electrically connected to each other.

17. The plasma display panel according to claim 16, wherein
at least two tips of the first transparent electrodes are electrically connected by means of the same material as that for the first transparent electrodes, and
at least two tips of the second transparent electrodes are electrically connected by means of the same material as that for the second transparent electrodes.

18. The plasma display panel according to claim 17, wherein
at least two tips of the plurality of first transparent electrodes are electrically connected by means of the same material as that for the plurality of first transparent electrodes, and
at least two tips of the plurality of second transparent electrodes are electrically connected by means of the same material as that for the plurality of second transparent electrodes.
